(19) United States
(12) Patent Application Publication
(10) Pub. No.: US 2014/0289875 A1
(43) Pub. Date: Sep. 25, 2014

(54) METHOD AND SYSTEM FOR ENSURING SENSITIVE DATA ARE NOT ACCESSIBLE

(71) Applicant: Roche Diagnostics Operations, Inc., Indianapolis, IN (US)

(72) Inventor: Andrzej Knafel, Walchwil (CH)

(73) Assignee: Roche Diagnostics Operations, Inc., Indianapolis, IN (US)

(21) Appl. No.: 14/199,291

(22) Filed: Mar. 6, 2014

(30) Foreign Application Priority Data
Mar. 22, 2013 (EP) 13160595.8

(51) Int. Cl. G06F 21/60

(52) U.S. Cl. CPC G06F 21/60
USPC 726/33

(57) ABSTRACT

A method and an analysis system that help ensure that sensitive data, including in particular patient data, are not accessible to unauthorized persons is presented. The method and system help prevent sensitive data stored on portable devices from being transported along with a portable device to a location outside of a security perimeter. By determining if a portable device is outside of the security perimeter and then automatically erasing the sensitive data stored on the portable device if that is the case, the method and system help prevent disclosure of sensitive data to unauthorized persons.

### CROSS-REFERENCE TO RELATED APPLICATIONS

This application is a continuation of EP 13160595.8, filed Mar. 22, 2013, which is hereby incorporated by reference.

### BACKGROUND

The present disclosure generally relates to the field of biological sample analysis systems and, in particular, to an analysis system securing sensitive patient data from unauthorized access.

Sensitive data such as, for example, biomedical measurement data generated by an analysis system having analyzed a biological sample of a patient, must be protected from unauthorized access. To an increasing degree, the lab personnel use portable processing devices such as notebooks, tablet-PCs and smart phones for analyzing sensitive data and/or for managing, monitoring and controlling lab devices or other lab-related items and tasks. The portable device may be used in different rooms within a laboratory, but may also be carried outside the lab building and outside a company's or university's premises, for example, in cases where the portable device is used for the job but also privately from home. This bears the risk that the portable device may be lost or stolen, for example, when a lab worker commutes on public transportion. Thus, sensitive data stored on the portable device may become accessible to unauthorized third parties.

Measurements for data protection on portable devices like password-authorization-based lock-mechanisms can easily be circumvented by a person having access to the hardware of the portable device and having specific knowledge and sufficient time. More secure lock-mechanisms based such as, for example, on cryptographic keys may require a complex key management which is often impractical to use.

One known system and method for restricting access to requested data is based on a location of the sender of the request. The described system and method requires the request-response system to be up and running. No protection is provided if the portable device is lost or stolen and if the unauthorized person has obtained possession of the hardware comprising the data to be protected.

Another known method and system for data protection for applications are registered with a storage cleaning mechanism. The registered applications can receive a notification of impending storage cleaning operations from the storage cleaning mechanism. Upon receiving the notification, the registered applications can release or unreference storage so it can be cleaned of data.

However, there is a need to provide an improved analysis system and method for securing sensitive patient data stored on a portable device.

### SUMMARY

According to the present disclosure, an analysis system and method for ensuring that sensitive data stored in a storage medium of a portable device are not accessible to unauthorized persons is presented. The sensitive data comprises patient data. The method comprises determining the current position of the portable device, determining whether the current position lies within a predefined security perimeter surrounding an analyzer of an analysis system, and if the current position is determined to lie outside the security perimeter, automatically erasing the sensitive data from the storage medium.

Accordingly, it is a feature of the embodiments of the present disclosure to provide an improved analysis system and method for securing sensitive patient data stored on a portable device. Other features of the embodiments of the present disclosure will be apparent in light of the description of the disclosure embodied herein.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates an analysis system comprising a portable device, a server, an analyzer and a further lab device according to an embodiment of the present disclosure.

FIG. 2 illustrates a block diagram of a portable device according to an embodiment of the present disclosure.

FIG. 3 illustrates a flowchart of a method executed by the portable device according to an embodiment of the present disclosure.

FIG. 4 illustrates a block diagram of two application programs interfacing with each other according to an embodiment of the present disclosure.

FIG. 5 illustrates a portable device moved outside a security perimeter according to an embodiment of the present disclosure.

FIG. 6 illustrates a process diagram of said movement according to an embodiment of the present disclosure.

### DETAILED DESCRIPTION

In the following detailed description of the embodiments, reference is made to the accompanying drawings that form a part hereof, and in which are shown by way of illustration, and not by way of limitation, specific embodiments in which the disclosure may be practiced. It is to be understood that other embodiments may be utilized and that logical, mechanical and electrical changes may be made without departing from the spirit and scope of the present disclosure.

A ‘user’ as used herein can be a human represented and identified by a user-ID uniquely assigned to the user. The user may have registered at a program logic as part of the IT infrastructure of a laboratory.

A ‘biological sample’ or ‘sample’ as used herein can be a quantity of biological material, such as blood, urine, saliva, tissue slices, and the like, for use in laboratory analyses or pre- and post-analytic processing.

The term ‘analyzer’ or ‘analytical lab-device’ as used herein can encompass any apparatus or apparatus component that can induce a reaction of a biological sample with a reagent for obtaining a measurement value. An analyzer can determine via various chemical, biological, physical, optical or other technical procedures a parameter value of the sample or a component thereof. An analyzer may measure the parameter of the sample or of at least one analyte and return the obtained measurement value. The list of possible analysis results returned by the analyzer can comprise, without limitation, concentrations of the analyte in the sample, a digital (yes or no) result indicating the existence of the analyte in the sample (corresponding to a concentration above the detection level), optical parameters, DNA or RNA sequences, data obtained from mass spectroscopy of proteins or metabolites and physical or chemical parameters of various types. The term analyzer as used herein can also encompass microscopes and any other kinds of lab devices to derive data from the sample which can be indicative of a certain physiological, biochemical or diagnostically relevant feature.

A ‘pre-analytical lab-device’ can be a lab device for executing one or more pre-analytical processing steps on one or more biological samples, thereby preparing the samples for one or more succeeding analytical tests. A pre-analytical processing step can be, for example, a centrifugation step, a capping-, decapping- or recapping step, an aliquotation step, a step of adding buffers to a sample and the like.

A ‘post-analytical lab-device’ can be a lab-device that can automatically process and/or store one or more analyzed biological samples. Post-analytical processing steps may comprise a recapping step, a step of unloading a sample from an analyzer or a step of transporting the sample to a storage unit or to a unit for collecting biological waste.

An ‘analysis system’ as used herein can comprise one or more analyzers. In addition, it may comprise one or more pre-analytical and/or post-analytical lab devices. An analysis system may comprise one or more control units operable to monitor and/or control the performance of the analyzer(s) and/or the pre-analytical and/or post-analytical lab devices. The control unit may evaluate and/or process gathered analysis data, to control the loading, storing and/or unloading of samples to and/or from the analyzer, to initialize an analysis or hardware or software operations of the analysis system used for preparing the samples, sample tubes or reagents for the analysis and the like. The one or more control units may be implemented as or comprise an application program installed on one or more portable devices which can be considered as being part of the analysis system irrespective of their current location.

The term ‘sensitive data’ as used herein can comprise patient data by which a patient can be identified. The patient data may comprise a patient name, a birthday, an address or portion of an address, and/or a patient identifier (for example, a social security number or health care insurance number, medical record identifier of the patient, email address or another unique identifier). In addition, the sensitive data may comprise medical and/or technical data such as, for example, lab device operation data and/or measurement data associated with the patient. The measurement data may be obtained by processing a biomedical sample of a patient. The measurement data may likewise be image data such as X-ray or NMR images, images of stained tissue slices or the like. The sensitive data may further comprise measurement values, but may also comprise previous or current diagnoses and treatment information, address information of the patient, a patient-ID or the like. Lab device operation data can be indicative of the type, operational state and/or the performance of a lab device. For example, the lab device operation data may comprise the number of samples processed per time, error statistics and parameters indicative of the quality of analysis. It may indicate if the lab-device runs out of reagents or consumables or was halted due to a technical error.

A ‘rule’ can be a computer interpretable set of instructions comprising at least one action and comprising one or multiple conditions, whereby the execution of the at least one action can depend on an evaluation of the one or more conditions in respect to one or more input values. Executing a rule can imply evaluating the conditions on the input value(s) and executing the at least one action in dependence on the evaluation result.

A ‘portable device’ as used herein can be any data processing device which can be portable by a human. For example, a portable device may be a notebook, a tabloid, a mobile phone, such as, a smart phone, or the like.

The term ‘biological sample’ can encompass any kind of tissue or body fluid having been derived from a human or any other organism. In particular, a biological sample can be a whole blood-, serum-, plasma-, urine-, cerebral-spinal fluid-, or saliva-sample or any derivative thereof.

A ‘security perimeter’ can be a geographic and/or spatial area whose boundaries can be stored in a storage medium of or accessible by the portable device and which can be considered as a protected zone in respect to data security. The security perimeter can surround an analyzer of an analysis system and can encompass a pre-defined area around the analyzer. The area defined by the security perimeter can be of any shape or size and can have sharply defined or approximately defined borders depending on the embodiment and location of the analyzer. Depending on the embodiment, the security perimeter may be specified as a circle with predefined center and radius, as a set of one or more buildings, as one or more rooms within a building, or the like. In particular, a security perimeter may be an area around the premises of a laboratory, a university, a hospital, or the like. The security perimeter can be defined, for example, by geoposition coordinates or the range of a transmitted signal (such as transmitted by a device in or near the analyzer), the loss of which by the portable device can indicate that perimeter has been exceeded. Alternatively, the security perimeter can be defined by transmitters that provide a signal to the portable device that can indicate the perimeter has been exceeded. Such transmitters can be transmitters located in one or more rooms surrounding the analyzer, through which a person carrying the portable device passes when leaving the vicinity of the analyzer.

A method for ensuring that sensitive data stored in a storage medium of a portable device are not accessible to unauthorized persons is disclosed. The sensitive data can comprise patient data. The portable device can determine its current position and can determine if its current position lies within a predefined security perimeter. The predefined security parameter can be defined such that it can surround an analyzer of an analysis system. If the current position is determined to lie outside the security perimeter, the portable device can automatically erase the sensitive data from the storage medium.

The features may ensure that if the portable device gets lost or stolen and moved outside the security perimeter, a location-dependent trigger mechanism can actively remove the sensitive data from the storage medium, thereby ruling out the possibility that an unauthorized user having access to the hardware can crack insufficient security measures and access the sensitive data.

Depending on the embodiment, the current position may be a geoposition such as, for example, a GPS (geo-positioning service) coordinate. Likewise, the current position may be any kind of indicator of a position of the device relative to elements of a given map or relative to a coordinate system. The current position may also be a room number and/or a building number, an identifier of a department or a lab or the like.

According to embodiments, the method can further comprise the analyzer analyzing one or more biological samples of a patient, thereby generating analytical measurement data. The analytical measurement data can be transmitted via a network from the analyzer to the portable device. The portable device can store the analytical measurement data in association with the sensitive data of the patient from whom the biological sample was drawn and who can be identified by the patient data contained in the sensitive data. The user of the portable device may evaluate the analytical measurement data of the patient and use the evaluation to submit commands for monitoring and/or controlling further pre-analytical, analytical or post-analytical sample processing steps from the portable device to the analysis system.

According to some embodiments, the erasing can be executed in accordance with one or more rules. The rules may be stored, for example, on the storage device of the portable device or may be stored on a central server and be retrieved dynamically from the server if needed. At least one of the rules can comprise a user-dependent erasing policy. The portable device can receive an identifier of the user. The identifier, also being referred herein as ‘user-ID’, may be received for example, upon the user logging into the portable device or into an application program running on the portable device and executing the above method. The portable device can execute the rules, thereby taking the user identifier, the determined current position and the security perimeter as input. The user ID may be used for selecting some user-specific rules. If the current position is determined to lie outside the security perimeter, the erasing can be user specific, whereby the amount and/or kind of the sensitive data that is erased can depend on the user identifier. The rules may be implemented for example, in the form of compiled program code or program scripts. They may be implemented as part of an application executed on the portable device.

According to some embodiments, each user can be assigned a role and corresponding role-ID. At least some of the rules can be role-specific and implement role-specific erasing policies. According to embodiments, the roles and the corresponding rules can be implemented in accordance with the ASTM Standard (American Society for Testing and Materials) E1986-09 and/or an ISO Standard such as ISO/TS 22600-1:2006, ISO/TS 22600-2:2006, ISO/DIS 22600-2, ISO/TS 22600-3:2009 and ISO/DIS 22600-3.

According to some embodiments, the storage medium of the portable device can be a non-volatile storage medium. This may have the advantage that in case of a power failure, the data can be easily recovered from the non-volatile storage medium provided the portable device was not moved outside the security perimeter.

According to other embodiments, the storage medium can be a volatile storage medium. The sensitive data can never persist in a non-volatile storage medium. This may further increase the security and may speed up the process of erasing the sensitive data.

According to further embodiments, the storage medium can comprise a volatile storage medium and a non-volatile storage medium respectively having stored the sensitive data or parts thereof. Erasing the sensitive data can comprise erasing the sensitive data from the volatile and from the non-volatile storage medium. The erasing policy may be different for both kinds of storage media. According to embodiments, the volatile storage medium can be the main memory of the portable device and the non-volatile storage medium can be a hard disk such as, for example, an electromagnetic storage device.

According to some embodiments, erasing the sensitive data from the storage medium can comprise erasing the sensitive data by formatting the storage medium or formatting a partition comprising the sensitive data; this may provide for a particularly save erasing procedure; or erasing the sensitive data by removing pointers to the sensitive data while leaving the sensitive data unchanged; this may provide for a particularly fast erasing procedure; or erasing the sensitive data by removing pointers to the sensitive data and overwriting the sensitive data with automatically generated data patterns; the automatically generated data pattern may e.g. be a random data pattern; this may provide for a particularly save erasing procedure as after the overwriting is executed one or multiple times, any information which may still be contained in the physical memory blocks on formerly stored sensitive data is removed; or changing or deleting a decryption key required for decrypting the sensitive data having been stored in the storage medium in an encrypted form. This may provide for a fast as well as secure way of erasing data. In some embodiments, multiple erasing strategies may be combined, for example, the decryption key may be deleted and the storage medium may be formatted in addition.

According to some embodiments, the portable device can request the sensitive data from a data source. The data source may be a lab device such as, for example, a pre-analytical, analytical or post-analytical lab-device, or a laboratory information system (LIS). The portable device can request the sensitive data only if its current position lies within the security perimeter at the moment of request submission. Then, the portable device can receive the requested sensitive data from the data source. The requirement of the portable device to lie within the security perimeter for receiving the data may increase the security as it can be ensured that also the data transfer can be executed within a secure zone.

The lab device or a server hosting the LIS may lie outside or inside the security perimeter and may comprise interfaces enabling the portable device to exchange data with the portable device. In addition, or alternatively, the lab-devices and the LIS may receive data management commands, device management commands and/or control commands from the portable device.

The sensitive data or parts thereof, for example, measurement data, may at first be transferred from a lab device having gathered the data to a data processing device, typically a computer is part of the LIS. The data processing device may act as an information hub for a plurality of other computers and lab devices of the lab and/or as a common interface for receiving control commands directed at the lab devices. The data processing device may collect measurement data, monitoring data and/or status information received from the lab devices. The transfer may be executed via a network, for example, the lab Intranet, or via a portable data carrier such as, for example, an USB-stick. The data processing device may transmit the data as the sensitive data to a requesting portable device within the security perimeter. In addition, or alternatively, the data processing device may receive control commands, requests for further sensitive data or the like from the portable device and may use the received commands for controlling data processing operations and/or for controlling the operation of the lab devices.

According to some embodiments, the erasing can comprise evaluating a data set which can comprise the sensitive data. The erasing can comprise selectively erasing the sensitive data while keeping the rest of the data set (for example, identifiers of patient records which do not identify the corresponding patient, identifiers and statistics related to lab devices and reagents, alert messages and the like) on the storage medium. In addition, or alternatively, the method may comprise storing or keeping stored identifiers of data records of the sensitive data to be erased from the storage medium. The storing or keeping stored can be executed in a way as to enable a restoring of the erased data records upon a future determination that the current position of the portable device lies within the security perimeter. The method may further comprise the portable device determining that its current position again lies within the security perimeter and restoring the erased data records based on the non-erased record identifiers. The data records may be restored, for example, by sending requests comprising the record identifiers from the portable device to a data processing device acting as data source, for example, a database server of the LIS, and retrieving the respective records identified via the record identifiers from the data source. This may be advantageous as the reconstruction and reloading of the data records may be accelerated without leaving any sensitive data on the portable device.

In other embodiments, erasing can comprise erasure of all data in a data set, either with or without the possibility to restore the erased data.

According to some embodiments, the portable device can display the lab device operation data to the user and can receive control input data entered by the user via a user interface. The user interface may be a keyboard, a microphone, a touch screen or the like. The control input data can be entered in dependence on the displayed lab device operation data; upon receipt of the input data, the portable device can submit a control command to a lab device in accordance with the entered control input data only if its current position lies within the security perimeter.

According to some embodiments, the portable device can continue to interactively request and can receive further sensitive data from the data source in dependence on some actions of the user on the portable device. The interactive request-response operations may be performed by a server program hosted by the data source and by a client program running on the portable device. As long as the current position of the portable device is determined to lie inside the security perimeter, the application of the portable device can store the received sensitive data in the storage medium. Upon determining that the current position lies outside the security perimeter, the application can erase the sensitive data.

According to some embodiments, the portable device currently lying within the security perimeter can automatically determine that a current distance between the portable device and the border of the security perimeter is below a distance threshold; this may happen when a user carrying the portable device is approaching the border of the security perimeter, for example, when leaving the lab at the end of a working day. In response to the determination, the portable device can output a notification to the user via a user interface of the portable device. The notification can indicate that the user is about to leave the security perimeter and that the sensitive data in this case can be erased. Thus, the user may stop his movement immediately in case he or she may be currently working with the sensitive data via the portable device and was about to leave the security perimeter accidentally. Data loss due to an accidental stepping outside the security perimeter may thus be prohibited. The interface may be a graphic interface, an acoustic interface or the like.

According to some embodiments, the portable device can erase the sensitive data in addition to any one of the following events: upon power-off of the portable device; upon a log-off event of the user from the portable device; upon shut-down of an application program executed on the portable device and performing the method of anyone of the previous embodiments; upon a log-off event of the user from said application program; upon receipt of an erasure command triggered by the user interacting with the portable device; and/or upon the portable device receiving an erasure command submitted by a data processing device located within the security perimeter.

According to embodiments, the determining of the current position and the decision if the sensitive data is erased can be continuously repeated such as, for example, upon fixed time intervals. In addition, the position dependent erasing may be executed upon receiving a user action such as, for example, a clicking of a button, an acceleration of the portable device along any of its axes, or the like.

According to some embodiments, the determining if the current position of the portable device lies within the security perimeter can comprise the portable device accessing geographic data stored in the storage medium or in a further storage device coupled to the portable device. The geographic data can comprise location coordinates specifying the security perimeter such as, for example, GPS data, one or more room-IDs and/or building-IDs and the like; then, the portable device can determine if current geographic coordinates of the determined current position of the portable device lie within the location coordinates of the security perimeter. According to some embodiments, the location coordinates specifying the security perimeter may be editable by the user or an operator, for example, via a graphical user interface, for facilitating the redefinition of the borders of the security perimeter.

The determination if the sensitive data can be erased and the data erasing may be performed by a first application program executed on the portable device. The portable device may be a mobile phone and the application program may be a so called ‘app’. The app may be implemented as native app wherein data can never be stored or cached to a storage medium of the portable device unless an explicit storage function of the app is executed. Alternatively, the app can be implemented as an internet browser executing a web-app provided by a second application running on the data processing device via a network. The data processing device may be a central server or one of the lab devices. Typically, a browser can cache any received data, but upon execution of the erasing of the sensitive data, the cache can be emptied.

The first application program can be interoperable with the second application program which can be executed on the data processing device. The data processing device may reside within or outside the security perimeter.

The first and second application programs can interactively enable the user to execute one or more of the following steps: Analyzing the sensitive data stored in the storage medium of the portable device; and/or editing or deleting individual data records of the sensitive data stored in the storage medium of the portable device via an interface of the portable device; any changes to the data records can be automatically propagated to and synchronized with a copy of the sensitive data stored in a central storage medium; the central storage medium may be part of the LIS and accessible by the portable device remotely; and/or controlling a lab device for stopping, initiating or rescheduling the pre-analytical, analytical or post-analytical processing of a patient sample in dependence on the sensitive data presented to the user via a graphical user interface of the first application program; and/or monitoring a lab device executing a pre-analytical, analytical or post-analytical processing of a patient sample.

The data processing device hosting the second application program may be a computer of a LIS, a processor of a lab-device, a device-control-computer or the like. The data processing device may also act as or comprise the data source providing the sensitive data to the portable device. The data processing device may comprise or be coupled to the central storage medium.

According to some embodiments, the determination if the sensitive data can be erased, the data erasing, the monitoring and/or controlling can be executed in a manner dependent on the user and dependent on the determined current position. The dependency can be implemented by rules executed by the first application program.

A computer-readable storage medium can comprise instructions which, when executed by a processor of a portable device can cause the processor to perform the method of any of the above embodiments.

An analysis system can ensure that sensitive data are not accessible to unauthorized persons. The sensitive data can comprise at least patient data. The analysis system can comprise at least one analyzer for analyzing biological samples and a portable device. The portable device can comprise a processor and a storage medium which can comprise the sensitive data. The portable device can further comprise a position device to determine a current position of the portable device. The positioning device may be implemented as GPS sensor, as a local positioning system (LPS) module or the like. The portable device can further comprise computer interpretable instructions of an application program which, upon execution by the processor, can cause the application program to execute a method comprising triggering the determination of the current position of the portable device and if the current position is determined to lie outside a security perimeter surrounding the at least one analyzer, causing the portable device to automatically erase the sensitive data from the storage medium.

Depending on the embodiment, the analyzer may be located at the center of the security perimeter or any other area within the security perimeter.

According to some embodiments, the position device can be location services provided by the manufacturer of the portable device. For example, the portable device may be a mobile phone and the location services may be provided by the manufacturer of the mobile phone as inbuilt hardware functionality.

According to some embodiments, the analysis system can further comprise one or more additional sample processing lab devices such as, for example pre-analytical and/or post-analytical lab devices. The additional sample processing lab devices may lie within the security perimeter or may lie outside the security parameter. The additional lab devices may be used for collecting additional sensitive data from the biological samples of a patient and for transmitting the sensitive data from the analysis system to the portable device. The additionally collected sensitive data may be measurement data.

The sample processing system may further comprise a data processing unit to forward the collected sensitive data to the application program of the portable device via a network. According to some embodiments, the data processing unit may be part of the analyzer or the additional lab device, thereby enabling the analyzer or the additional lab device to act as data source and to directly forward the sensitive data to the portable device. The sample processing system can further comprise a configuration unit allowing the first user or a second user to specify location coordinates of the security perimeter and/or to configure user-specific and/or position specific rules determining how the erasing can be executed. The configuration unit may be part of the portable device and/or may be hosted by a data processing device connected to the portable device via a network.

The configuration may be executed by an operator of the lab remotely or by the user of the portable device via an interface of the portable device. The configuration may require the user or operator to authenticate at the LIS and/or the application program running on the portable device. The configuration via an interface of the portable device can be prohibited by the portable device if its current position lies outside the security perimeter.

Referring initially to FIG. 1, FIG. 1 shows a distributed analysis system 100 for ensuring that sensitive data stored in a storage medium of a portable device 104 of a user 102 are not accessible to unauthorized persons. This can be ensured by the portable device 104 automatically erasing the sensitive data from its storage medium upon the user 102 leaving a security perimeter 110. The security perimeter 110 can be considered as the geographic area wherein sensitive data stored on the portable device 104 can be considered to be safe.

The system 100 can comprise a server 120 having a data processing unit 122 and a configuration unit 124. The server 120 can further comprise an application program 128 interfacing with an application program running on the portable device 104. An operator 126 may use the configuration unit 124 for configuring some rules stored in the server 120 or the portable device 104 which can be responsible for executing the data erasure.

The system 100 can further comprise an analyzer 112 which can analyze some biological samples 114 of one or more patients. Measurement data gathered by the analyzer 112 can be transferred to the server 120. The biological samples 114 may have been prepared for the analysis by a pre-analytical lab device 130 which may also send some patient-related data to the server 120. The server 120 can gather sensitive data from one or more lab devices which may lie within (as the analyzer 112) or outside (as the pre-analytical lab device 130) the security perimeter 110. The server 120 may then transfer the gathered sensitive data to the portable device 104 for enabling a user 102, for example, a nurse or another medical professional or a technician to evaluate the sensitive data and/or to monitor or control the ongoing pre-analytical, analytical or post-analytical sample processing. The data transfer may be executed via a mobile phone connection. The server 120 or any lab-device acting as data source can reside within the security perimeter 110 or within another protected zone to protect the sensitive data from the beginning. In other embodiments, one or more of the lab devices acting as data sources may directly interface with the portable device 104.

The user 102 carrying his portable device 104 is depicted at two different positions 116, 106. When the portable device 104 determines by its positioning unit its current position 116 to lie within the security perimeter 110, the sensitive data can be transferred from the server 120 to the portable device 104 for storing the sensitive data at least temporarily to a storage medium of the portable device 104 for enabling the user 102 to evaluate the sensitive data. When the portable device 104 determines its current position 106 to lie outside the security perimeter 110, the portable device 104 can automatically erase the sensitive data stored in its storage medium.

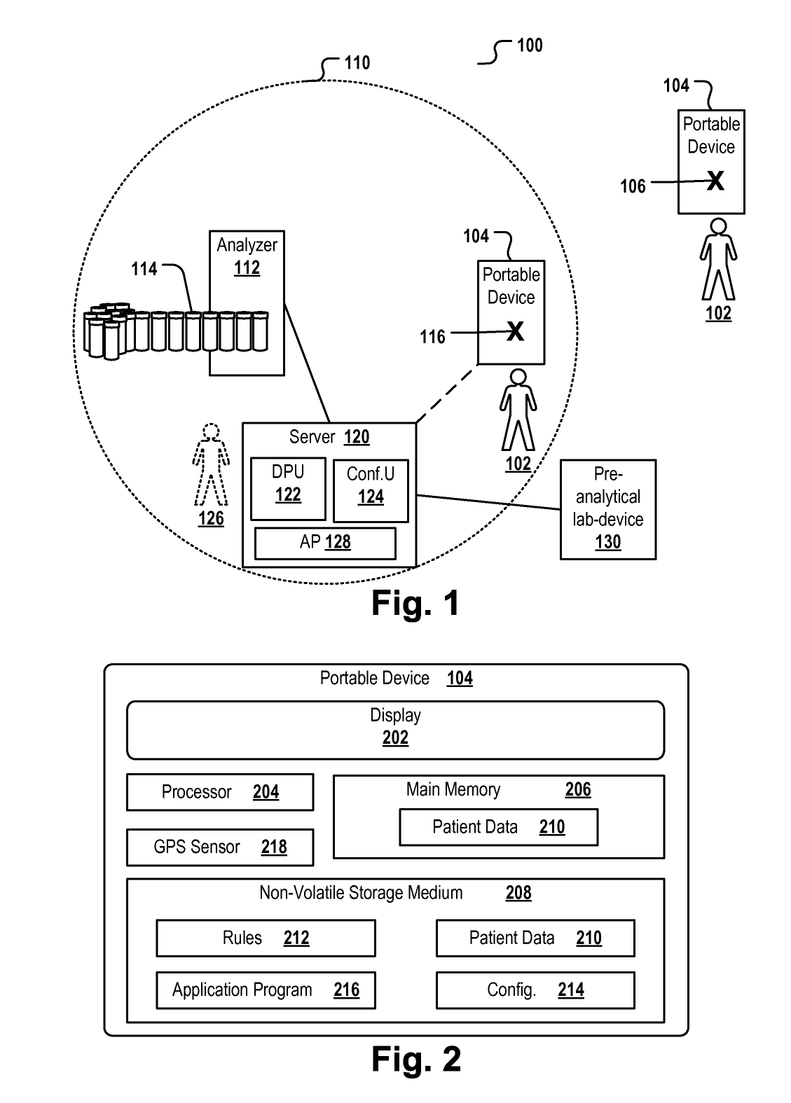

FIG. 2 shows a block diagram of the portable device 104 and its components. The portable device 104 can comprise a positioning unit 218, in this case a GPS sensor, for determining its current position. It can comprise a processor 204 and a main memory 206. Sensitive data 210 which may have been entered by the user 102 into the portable device 104 and/or which may have been received from the server 120 is stored in the main memory 206. In addition, the portable device 104 can comprise a non-volatile storage medium 208 comprising a copy of the sensitive data 210 or parts thereof. The storage medium 208 may also comprise some rules 212 for erasing the sensitive data 210 from the main memory 206 and/or from the non-volatile storage medium 208 in case the positioning unit 218 determines that the portable device 104 is outside the security perimeter 110. A configuration module 214 can enable a user 102 to configure the rules and/or the borders of the security perimeter 110 stored in the portable device 104 via a user interface of the portable device 104. In addition or alternatively, the rules and/or the borders of the security perimeter 110 may be configured by an operator 126 of the analysis system remotely.

Application program 216 can execute the rules for erasing the sensitive data 210 in dependence on input received from the positioning unit 218. The application program 216 may be able to receive a user identifier from a user 102 for providing the user-ID as input to the rules 212 and for executing them in a user-specific manner. For example, some users may be considered as particularly trustworthy and reliable and the erasure of the data in this case may be limited to a particularly sensitive subset of the sensitive data 210.

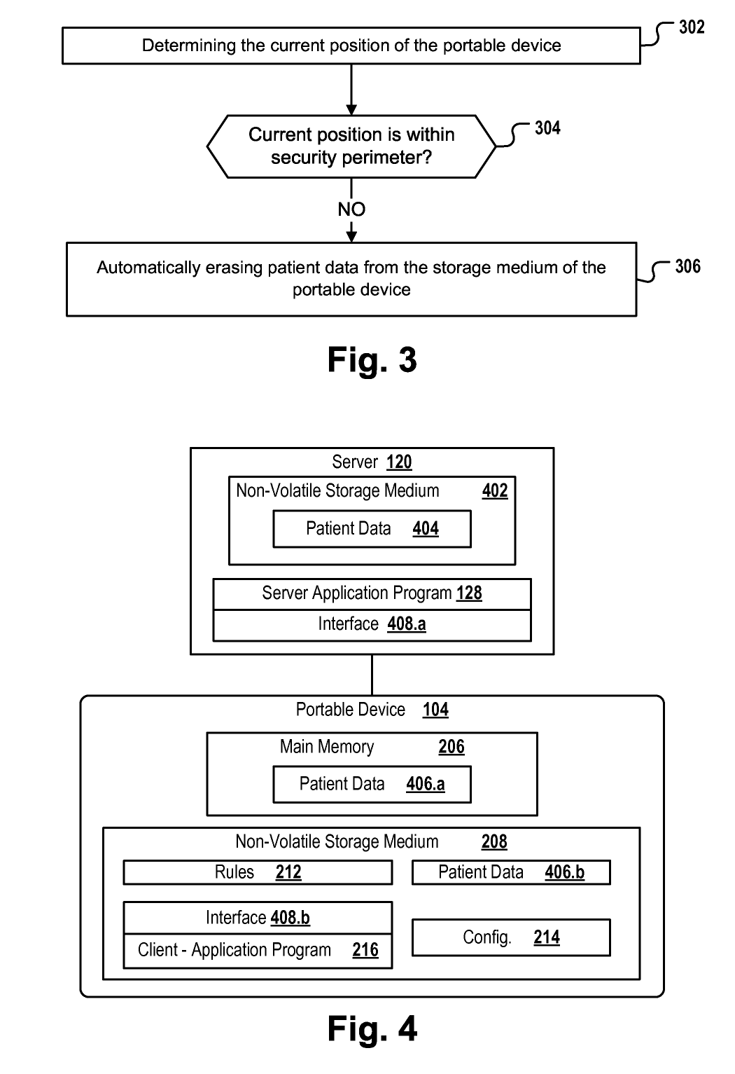

FIG. 3 shows a flowchart of a method executed by a portable device 104 according to one embodiment for ensuring that sensitive data 210 stored in a storage medium 206, 208 of the portable device 104 cannot be accessed by an unauthorized person. In step 302, the portable device 104 can determine its current position. In step 304, the portable device 104 can determine if its current position lies within a predefined security perimeter 110 surrounding an analyzer 112 of an analysis system 100. This may be done for example by comparing the current position of the portable device 104 with a set of location coordinates specifying the security perimeter 110. The set of location coordinates may have the form of a geographic map. In case the current position of the portable device 104 was determined to lay outside the security perimeter 110, in step 306, the portable device 104, for example, by executing some rules 212, can erase the sensitive data 210 from the storage medium 208 of the portable device 104.

FIG. 4 shows some components of a server 120 and a portable device 104 according to another embodiment. The application program 216 can comprise an interface 408.b for receiving sensitive data from a server application program 128 run by the server 120 and comprising a corresponding interface 408.a. Application programs 216 and 128 may be interoperable for transferring sensitive data from the server 120 acting as a data source to the portable device 104. Thereby, application program 128 may act as server application program 128 and application program 216 may act as corresponding client application program. Both application programs may exchange requests and respective responses as depicted in greater detail in FIG. 6.

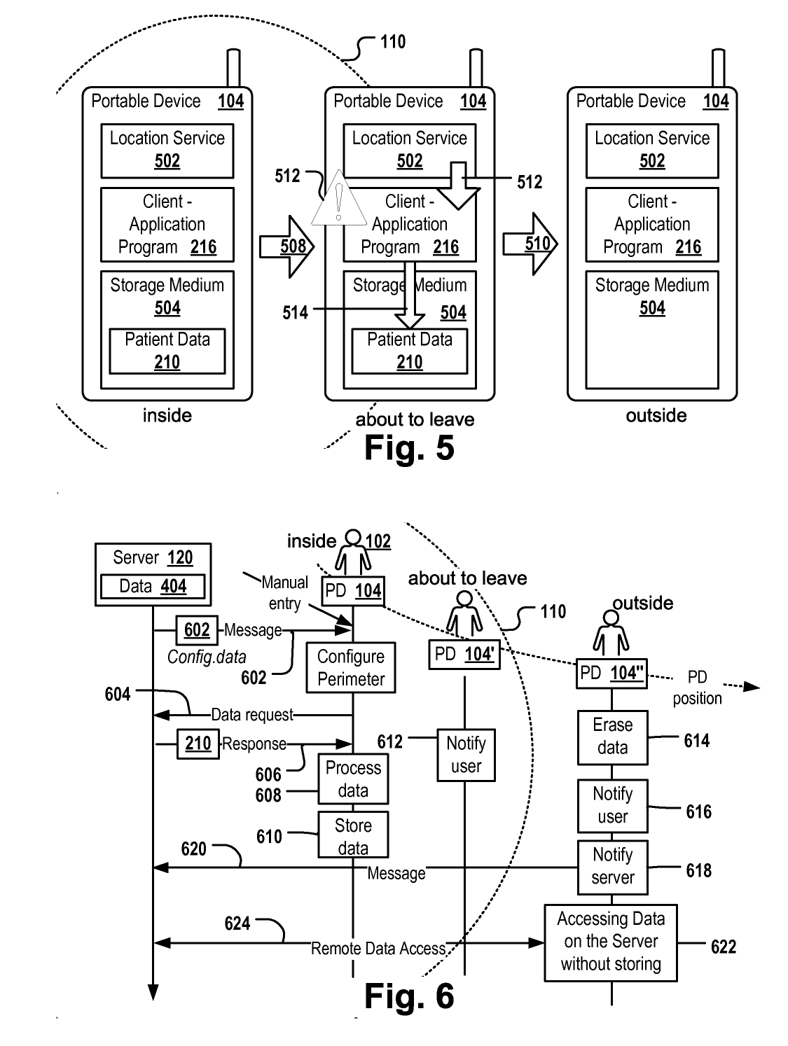

FIG. 5 shows a single portable device 104 at three different positions inside, at the border of and outside of the security perimeter 110. The portable device 104 can comprise a positioning unit in the form of a location service 502 callable by the application program 216 for determining the current position of the portable device 104. Upon receiving a call of the application program 216, the location service 502 can execute the positioning module 218 and can return the current position to the application program 216. The application program 216 can have access to a predefined and preferentially configurable set of location coordinates specifying the boundaries of the security perimeter 110. The location coordinates may be stored in an internal storage medium 504 of the portable device 104 or an external storage medium accessible by the portable device 104. By comparing the current position with the location coordinates of the security perimeter 110, the application program 216 can determine that it currently lies within the security perimeter 110 and that the sensitive data 210 can be stored or kept stored on storage medium 504 without any security risk. Storage medium 504 may be volatile or non-volatile or a combination thereof.

Arrow 508 can indicate that a user 102 of the portable device 104 approaches the boundary of the security perimeter 110. The application program 216 may call the location service 502 on a regular basis, for example, every second. By comparing the current position of the portable device 104 with the location coordinates of the security perimeter 110, the application program 216 may determine if the portable device 104 is less than a predefined, configurable minimum distance away from the boundary of the security perimeter 110. In this case, the application program 216 can output a notification 512 to the user 102 that the sensitive data 210 is to be erased from the storage medium 504 if the user 102 continues approaching the border of the security perimeter 110. For example, the security perimeter 110 may be a circular area around a geographic point within a healthcare organization having a radius of about 200 meter. The minimum distance may be about 20 meter. Thus, an accidental erasure of the sensitive data 210 by a user 102 accidentally stepping outside the security perimeter 110 can be prohibited. If the user 102 intentionally wants to leave the security perimeter 110, he may finish data analysis and submit the evaluation results or control commands to the application program 128 running on a processing device within the security perimeter 110 and interfacing with the application program 216 of the portable device 104. The sensitive data 210 can then be erased by the application program 216 upon the user 102 leaving the security perimeter 110 as indicated by arrow 510. At the “outside” position, the storage medium 504 cannot comprise the sensitive data 210 anymore.

FIG. 6 depicts a process diagram of the server 120 and the portable device 104 exchanging some requests and respective responses which may be executed upon a user 102 carrying the portable device 104 outside the security perimeter 110. At the beginning, an operator of the server 120 may remotely configure the rules and/or the location coordinates specifying the security perimeter 110. A corresponding message 602 comprising the configuration data is transferred from the server 102 to the portable device 104. The configuration data can be used for configuring the location coordinates of the security perimeter 110 stored in a storage medium 504 accessible by application program 216 of the portable device 104.

Then, the client application program 216 of the portable device 104 residing within the security perimeter 110 can submit a data request 604 to the server 120 and can receive some sensitive data 210 contained in a respective response 606. The received sensitive data 210 may be processed and evaluated by the user 102. The received and/or the processed sensitive data 210 can be stored in step 610 on a storage medium 504 of the portable device 104. The location service 502 may be called on a regular basis. As long as the user 102 and the portable device 104 reside within the security perimeter 110, additional data requests 604 and respective responses may be exchanged between the portable device 104 and the server 120 while processing and/or evaluating the sensitive data 210 by the portable device 104 and the user 102. In addition, there may be some control commands submitted by the portable device 104 in response to a user action to the server 120 for controlling the processing of a biological sample 114 of by a lab device. In addition or alternatively, monitoring information may be received by the portable device 104 from one or more lab devices or the analyzer 112 directly or via the server 120.

In case the client application program 216 of the portable device 104 determines that the user 102 is about to leave the security perimeter 110, a notification 512 can be output in step 612 to the user 102 for ensuring that the sensitive data 210 is not erased accidentally and evaluation results might get lost because they could not be submitted to the server 120 in time before leaving the security perimeter 110. The notification 512 may be an acoustic signal, a displayed warning message or the like.

Then, in case the portable device 104 determines that its current position lies outside the security perimeter 110, the portable device 104 (to be more particular: its application program 216) can erase in step 614 the sensitive data 210 stored on the storage medium 504 of the portable device 104. Finally, in step 616, the user 102 may be notified that the sensitive data 210 was erased. In addition or alternatively, in step 618, a message can be sent from the portable device 104 to the server 120 for notifying to the server 120 that the sensitive data 210 was deleted.

According to some embodiments, a storage medium 402 of the server 120 or coupled to the server 120 can also comprise the sensitive data 404 and a synchronization of the sensitive data 404 evaluated and modified on the portable device 104 and the sensitive data 404 on storage medium 402 can be executed via automated request response cycles executed in the background. Thus, the sensitive data 404 on storage medium 402 can continuously be synchronized with the sensitive data 406.a stored on the storage medium 206 of the portable device 104 which may be modified by the user 102. In case a user 102 has left the security perimeter 110 and has the appropriate privileges, in step 622, the user 102 may access the sensitive data 404 stored in storage medium 402 directly via a network connection 624.

It is noted that terms like “preferably,” “commonly,” and “typically” are not utilized herein to limit the scope of the claimed embodiments or to imply that certain features are critical, essential, or even important to the structure or function of the claimed embodiments. Rather, these terms are merely intended to highlight alternative or additional features that may or may not be utilized in a particular embodiment of the present disclosure.

For the purposes of describing and defining the present disclosure, it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the present disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure.

We claim:

1. A method for ensuring that sensitive data stored in a storage medium of a portable device are not accessible to unauthorized persons, wherein the sensitive data comprising patient data, the method comprising:
determining the portable device's current position;
determining whether the current position lies within a predefined security perimeter surrounding an analyzer of an analysis system;
if the current position is determined to lie outside the security perimeter, automatically erasing the sensitive data from the storage medium.

2. The method according to claim 1, wherein the erasing is executed in accordance with one or more rules, wherein at least one of the rules comprises a user-dependent erasing policy, the method further comprising:
receiving an identifier of the user;
executing the rules taking the user identifier, the determined current position and the security perimeter as input, wherein if the current position is determined to lie outside the security perimeter, the erasing is user-specific, wherein the amount and/or kind of the sensitive data erased depends on the user identifier.

3. The method according to claim 1, wherein the erasing of the sensitive data from the storage medium comprises
erasing the sensitive data by formatting the storage medium or formatting a partition comprising the sensitive data; or
erasing the sensitive data by removing pointers to the sensitive data while leaving the sensitive data unchanged; or
erasing the sensitive data by removing pointers to the sensitive data and overwriting the sensitive data with automatically generated data patterns; or
changing or deleting a decryption key required for decrypting the sensitive data having been stored in the storage medium in an encrypted form.

4. The method according to claim 1, further comprising,
requesting the sensitive data from a data source only if the current position of the portable device lies within the security perimeter at the moment of request submission; and
receiving the requested sensitive data from the data source by the portable device.

5. The method of claim 4, wherein the data source is a pre-analytical, analytical or post-analytical lab-device or a laboratory information system.

6. The method according to claim 1, wherein the erasing comprises evaluating a data set comprising the sensitive data and selectively erasing the sensitive data while keeping the rest of the data set on the storage medium.

7. The method according to claim 1, wherein the erasing comprises storing identifiers of data records of the sensitive data to be erased in the storage medium in a way as to enabling a restoring of the erased data records upon a future determination by the portable device that the current position of the portable device lies within the security perimeter.

8. The method according to claim 1, further comprising,
displaying the lab-device operation data to the user;
receiving control input data entered by the user via a user-interface in dependence on the displayed lab-device operation data; and
submitting a control command to a lab-device in accordance with the entered control input data only if the current position of the portable device lies within the security perimeter.

9. The method according to claim 1, further comprising,
automatically determining that a current distance between the portable device and the border of the security perimeter is below a distance threshold when the portable device is currently lying within the security perimeter; and
in response to the determination, outputting a notification via a user interface of the portable device to the user, wherein the notification indicates that the user is about to leave the security perimeter and that the sensitive data will be erased.

10. The method according to claim 1, wherein the erasing of the sensitive data is performed in addition to any of the following events: upon power-off of the portable device, upon a log-off event of the user from the portable device, upon shut-down of an application program executed on the portable device and performing the method of anyone of the previous claims, upon a log-off event of the user from said application program, upon receipt of an erasure command triggered by the user interacting with the portable device, and upon the portable device receiving an erasure command submitted by a data processing system located within the security perimeter.

11. The method according to claim 1, wherein the determining of the current position and the decision to erase the sensitive data is repeated continuously.

12. The method according to claim 1, wherein the determining if the current position of the portable device lies within the security perimeter comprises the portable device accessing geographic data stored in the storage medium or in a further storage device operatively coupled to the portable device and determining if current geographic coordinates of the determined current position lie within the location coordinates of the security perimeter.

13. The method of claim 12, wherein the geographic data comprises location coordinates specifying the security perimeter.

14. The method according to claim 1, wherein the determination if the sensitive data is to be erased and the data erasing is performed by a first application program executed on the portable device, wherein the first application program is interoperable with a second application program executed on a data processing device, wherein the first and second application programs interactively enabling the user to:
analyzing the sensitive data stored in the storage medium; and/or
editing or deleting individual data records of the sensitive data stored in the storage medium of the portable device via an interface of the portable device, wherein any changes to the data records are automatically propagated to and synchronized with a copy of the sensitive data stored in a central storage medium; and/or
controlling a lab device for stopping, initiating or rescheduling the pre-analytical, analytical or post-analytical processing of a patient sample in dependence on the sensitive data presented to the user via a graphical user interface of the first application program; and/or
monitoring a lab device executing a pre-analytical, analytical or post-analytical processing of a patient sample.

15. The method according to claim 14, wherein the determination if the sensitive data is to be erased, the data erasing, the monitoring and/or controlling are executed in a manner depended on the user identifier or a role identifier and dependent on the determined current position, wherein the dependency is implemented by rules executed by the first application program.

16. The method according to claim 1, wherein sensitive data stored on the storage medium of the portable device is continuously synchronized with a further storage medium of a server while the portable device is within the predefined security perimeter, thereby enabling storage, in the further storage medium of the server, of sensitive data modified on the portable device so that the modified sensitive data can be accessed by an authorized user outside of the predefined security perimeter.

17. A computer-readable storage medium comprising instructions which, when executed by a processor of a portable device cause the processor to perform the method claim 1.

18. An analysis system which ensures that sensitive data are not accessible to unauthorized persons, wherein the sensitive data comprising patient data, the analysis system comprising:
at least one analyzer for analyzing biological samples; and
a portable device comprising a processor, a storage medium comprising the sensitive data, position device to determine a current position of the portable device, and computer-interpretable instructions of an application program which, upon execution by the processor, cause the application program to execute a method comprising:
triggering the determination of the current position, and
if the current position is determined to lie outside a security perimeter surrounding the at least one analyzer, automatically erasing the sensitive data from the storage of the portable device.

19. The analysis system of claim 18, further comprising
a sample processing system, wherein at least parts of the sensitive data are collected from the at least one analyzer, comprising,
a data processing unit lying within the security perimeter and operable to forward the collected sensitive data to the application program of the portable device via a network; and
a configuration unit allowing the first user or a second user to specify location coordinates of the security perimeter and/or to configure user-specific and/or position specific rules determining how the erasing is executed.
